(19) United States
(12) Patent Application Publication
(10) Pub. No.: US 2013/0048641 A1
(43) Pub. Date: Feb. 28, 2013

(54) TRASH CONTAINER WITH EASILY REMOVABLE BAG AND INTERLOCKING RING

(71) Applicant: Stephen Romano, Tamarac, FL (US)

(72) Inventor: Stephen Romano, Tamarac, FL (US)

(73) Assignee: Supreme Innovations, LLC, Tamarac, FL (US)

(21) Appl. No.: 13/593,290

(22) Filed: Aug. 23, 2012

Related U.S. Application Data
(60) Provisional application No. 61/526,835, filed on Aug. 24, 2011.
(60) Provisional application No. 61/667,445, filed on Jul. 3, 2012.

(51) Int. Cl. B65F 1/06; B65F 1/14

(52) U.S. Cl. 220/495.08; 220/263; 220/610; 220/4.09; 29/426.1; 29/428

(57) ABSTRACT

Disclosed is a trash container with a user actuated release mechanism that releases the container from the base allowing lifting of the container off the base, thereby leaving the filled trash bag disposed on the base of the trash can. The trash container of the present invention enables removal of the trash bag without requiring lifting of the filled trash bag to the top of the trash container. In this manner, the filled trash bag can be dragged or lifted slightly when being taken out to the curbside for pickup. In another embodiment of a trash container, a door panel is locked in place using a locking ring that once removed enables opening of the door panel to remove the trash bag. In this manner, the filled trash bag can be dragged or lifted slightly when being taken out to the curbside for pickup.

### RELATED APPLICATIONS

This application claims priority to U.S. Provisional Patent Application No. 61/526,835 filed Aug. 24, 2011 by the same inventor and entitled “Trash Container with Easily Removable Bag.” This application also claims priority to U.S. Provisional Patent Application No. 61/667,445 filed Jul. 3, 2012 by the same inventor and entitled “Trash Container with Easily Removable Bag and Interlocking Ring.” U.S. Provisional Patent Application Nos. 61/526,835 and 61/667,445 are hereby incorporated by reference in their entireties, including the drawings, as if repeated herein in their entireties.

### BACKGROUND

The present invention relates generally to trash containers, and more particularly to a trash container having a liner for accepting a plastic bag.

Removing a plastic trash bag from a garbage container becomes difficult primarily due to a vacuum seal that is formed between the bag and the container. Lifting a trash-filled bag from the container typically creates a vacuum between the bag and the container bottom and sides. Difficulty increases for the elderly and the physically impaired when trying to lift weight due to the filled bag while simultaneously fighting this vacuum. Additionally, even if the vacuum is minimal or eliminated, friction between the bag and the container sill inhibits bag removal, as many containers are relatively light weight and simply lift off of the floor along with attempts to lift the bag from within. A lack of sturdiness of most containers can further inhibit the separation of bag and container, as the container is difficult to hold in a non-flexing posture. Complicating this problem is the need to solve the problem without increasing the cost of the trash container, as consumers will not pay for increased costs associated with a trash can. Therefore, what is needed is an inexpensive trash container that solves the aforesaid problems.

### SUMMARY OF THE INVENTION

The present invention solves these and other problems by providing trash container with a user actuated release mechanism that releases the container from the base allowing lifting of the container off the base without the filled trash bag, thereby leaving the filled trash bag disposed on the base of the trash can. The trash container of the present invention enables removal of the trash bag without requiring lifting of the filled trash bag to the top of the trash container. In this manner, the filled trash bag can be dragged or lifted slightly when being taken out to the curbside for pickup.

According to one aspect of the present invention, an exemplary embodiment of a trash container includes a cylindrical liner that attaches to a base unit. The liner and the base unit are locked together via an actuating mechanism. The actuating mechanism locks the liner to the base unit when the liner is lowered onto the base unit and force is applied to the top of the liner. When the user applies a small force, the actuating mechanism “clicks” to lock the liner to the base. Once locked to the base, the liner can accept a plastic bag, into which garbage is placed over time. A foot operated release disengages the actuating mechanism so that the liner is released from the base. Then, the liner may be easily lifted from the base unit leaving the garbage filled plastic bag sitting on the base unit. A foot operated release pushes a rod that engages the actuating mechanism rotating the actuating mechanism outside of the liner, thereby releasing the liner from the base. When the liner is lowered, pressure applied to the top of the liner depresses the foot operated release, thereby enabling the actuating mechanism to rotate into a recess or slot in the liner that accepts the actuating mechanism. Once the actuating mechanism is properly inside the recess or slot, the actuating mechanism provides a “click” indicating that the liner is properly placed on the base and locked in position, so a plastic bag may then be introduced into the liner.

According to another aspect of the present invention, a trash container is provided with an interlocking ring that engages with a door, which can be opened when the interlocking ring is removed. In this manner, the filled trash bag can be dragged or lifted slightly when being taken out to the curbside for pickup.

According to another aspect of the present invention, an exemplary embodiment of a trash container includes an inner liner upon which a trash bag sits. The inner liner fits inside the outer container, but is somewhat smaller in height to enable a filled trash bag to be easily lifted over the top of the inner liner. An interlocking ring fits over the top of the door so that the door cannot be removed while the ring remains in place. Once the ring is removed, the door can be operated. The door can be hinged at the side, at the bottom or at the top. Alternatively, the door can be formed to slide into place. A foot pedal enables the user to open the lid of the trash container to place trash in the bag.

### BRIEF DESCRIPTION OF THE DRAWINGS

FIG. 1 depicts an exemplary embodiment of trash container according to one aspect of the present invention as shown in a side view.

FIG. 2 depicts the exemplary embodiment of the trash container from FIG. 1 as shown in a top view.

FIG. 3 depicts another exemplary embodiment of a trash container according to another aspect of the present invention shown in a top view.

FIG. 4 depicts another exemplary embodiment of a trash container according to another aspect of the present invention shown in a side view.

FIG. 5 depicts the base unit of the exemplary embodiment of FIGS. 3-4 shown in a top view.

FIG. 6 depicts another exemplary embodiment of trash container according to yet another aspect of the present invention.

FIG. 7 depicts yet another exemplary embodiment of trash container according to still another aspect of the present invention.

FIG. 8 depicts yet another exemplary embodiment of a trash container according to yet another aspect of the present invention.

### DETAILED DESCRIPTION

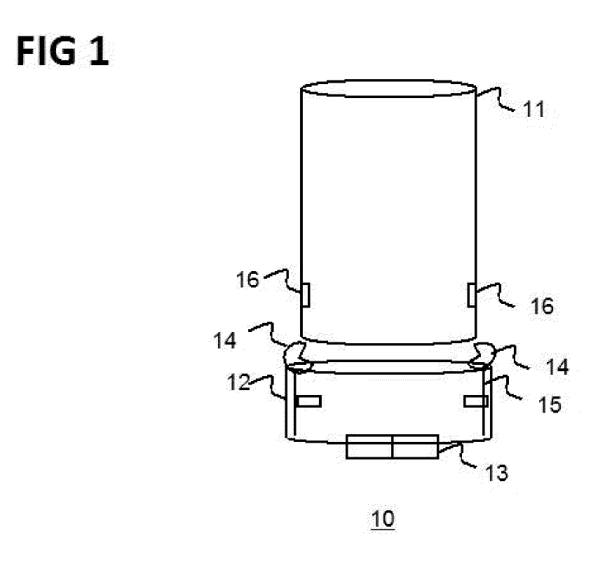

Turning to FIG. 1, shown therein is an exemplary embodiment of a trash can 10 according to one aspect of the present invention. The trash can 10 includes a liner or container 11 that attaches to a base unit 12.

A lid (not shown) may be placed on the liner 11. The lid should be designed to fit the shape of the liner 11. A typical foot operated lid may be used along with the trash container 11 of the present invention. Alternatively, a lid that is removed manually may be employed.

The base unit 12 includes at least a foot operated release mechanism or pedal 13 to enable the user to release the base unit 12 from the container 11. The base unit 12 is also designed to fit the shape of the liner 11.

An actuating mechanism 14 is used to enable the container 11 to be locked to the base 12 and to be released from the base 12. The actuating mechanism 14 couples with the foot pedal 13 to accept a force from a user to release the container 11 from the base 12. The foot pedal 13 is affixed to the base unit 12 via a pin (not shown) at the center of the foot pedal 13 that enables the lever 13 to move up and down at each end. The weight of the container 11 is sufficient to maintain the lever 13 in a position whereby the portion of the foot pedal 13 that accepts the user's foot is normally in the upwards position. Pressing one's foot on the foot pedal 13 moves the foot pedal 13 to its lowest or bottom position at the end that engages with the foot. The opposite end then moves upward. The upward movement of the opposite end of the foot pedal 13 moves a vertical rod 15 upwards. When the foot is removed from the foot pedal 13, the opposite end of the foot pedal 13 then returns to the downward or bottom position, thereby moving the vertical rod 15 downwards. Thus, depressing the foot pedal 13 moves the rod 15 upwards and removing the foot from the foot pedal 13 enables the rod 15 to return to its lowest position.

One end of the rod 15 engages with a rotating actuator 14, which rotates one direction as the rod 15 moves vertically upwards and rotates the opposite direction as the vertical rod 15 moves downwards. The rotating actuator 14 is spring loaded so that absent any pressure from the vertical rod 15, the rotating actuator 14 remains engaged with its corresponding recess or slot 16 in the container 11. The rotating actuator 14 is shaped to fit into a slot or recess 16 disposed in the side of container 11. Multiple rotating actuators 14 may be employed to provide symmetry to the lock. Two actuators 14 are preferable, however, one will suffice.

The container 11 used in the present invention may be cylindrical in shape or have a square cross-section, or any other shape without departing from the scope of the present invention. The container 11 includes one or more recesses or slots 16 disposed in the sides of the container 11. The location of the one or more recesses or slots 16 is preferably towards the end of the container 11 that engages with the base unit 12, as this decreases the length of the rod 15 or mechanism that transfers the foot applied force from the base unit 12 up to the point at which the locking mechanism 14 engages with the slots or recesses 16 in container 11.

The liner and the base unit are locked together via the actuating mechanism 14. The actuating mechanism 14 locks the liner 11 to the base unit 12 when the liner 11 is lowered onto the base unit 12 and force is applied to the top of the liner 11. When the user applies a small force, the actuating mechanism 14 “clicks” to lock the liner 11 to the base 12. Once locked to the base 12, the liner 11 can accept a plastic bag (not shown), into which garbage is placed over time. A foot operated release 13 disengages the actuating mechanism 14 from the liner 11 so that the liner 11 is released from the base 12. Then, the 11 liner may be easily lifted from the base unit 12 leaving the garbage filled plastic bag sitting on the base unit. A foot operated release 13 pushes a rod 15 that engages the actuating mechanism 14 rotating the actuating mechanism 14 outside of the slots or recesses 16 in liner 11, thereby releasing the liner 11 from the base 12. When the liner 11 is lowered, pressure applied to the top of the liner 11 depresses the foot operated release 13, thereby enabling the actuating mechanism 14 to rotate into a recess or slot 16 in the liner 11 that accepts the actuating mechanism 14. Once the actuating mechanism 14 is properly inside the recess or slot 16, the actuating mechanism 14 provides a “click” indicating that the liner 11 is properly placed on the base 12 and locked in position, so a plastic bag may then be introduced into the liner 11.

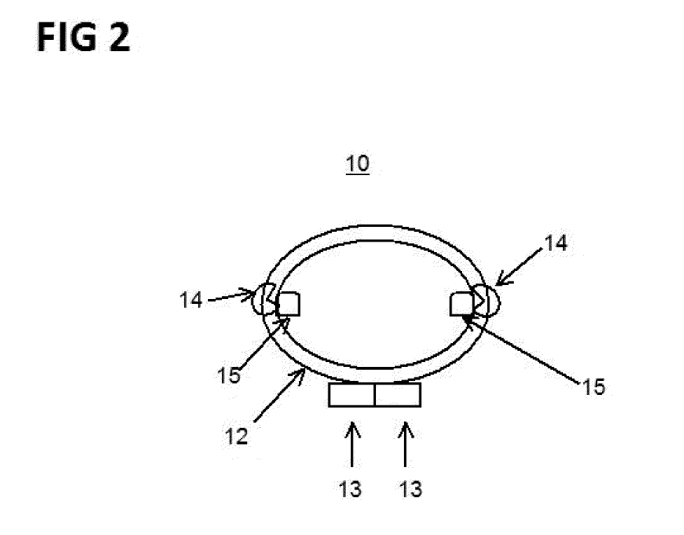

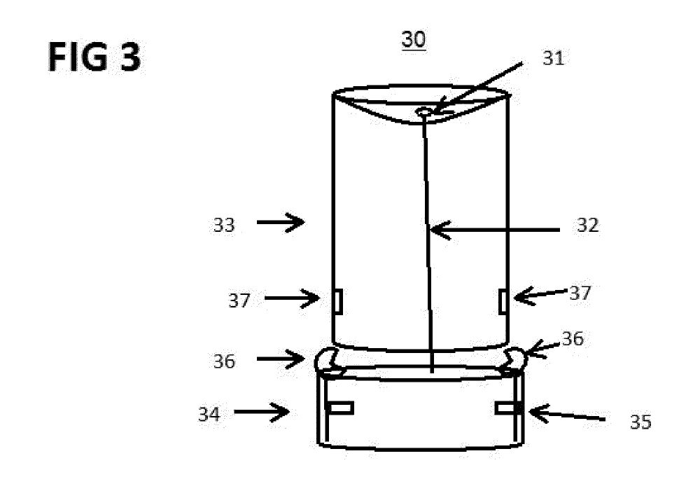

Turning to FIG. 3, shown therein is another exemplary embodiment of a trash container 30 according to the present invention shown in a front view. Embodiment 30 employs a button 31 on the top of the container 30 to release the locks 36 that enable removal of the can cylinder 33 from the base 34, similar to the pedals in the embodiment of FIGS. 1-2. Lock actuator platform 35 lowers when can cylinder 33 engages which rotates locks 36 into locking position 37. Rod 32 connects button 31 to actuating mechanism (not shown) in base 35.

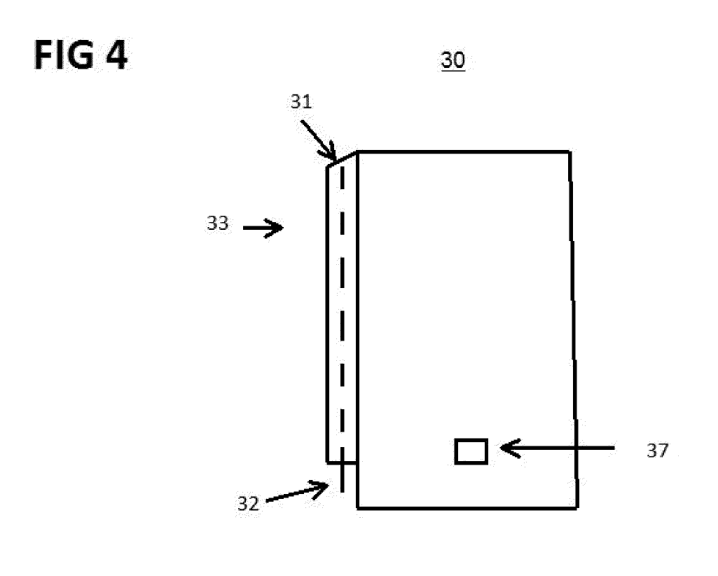

Turning to FIG. 4, shown therein is a side view of the embodiment 30 of FIG. 3 with the actuator button 31 disposed on top of the can cylinder 33. Rod 32 which is hidden inside the can cylinder engages the actuating mechanism when the can cylinder 33 is placed in the base 34. Recesses 37 are where the locks 36 engage.

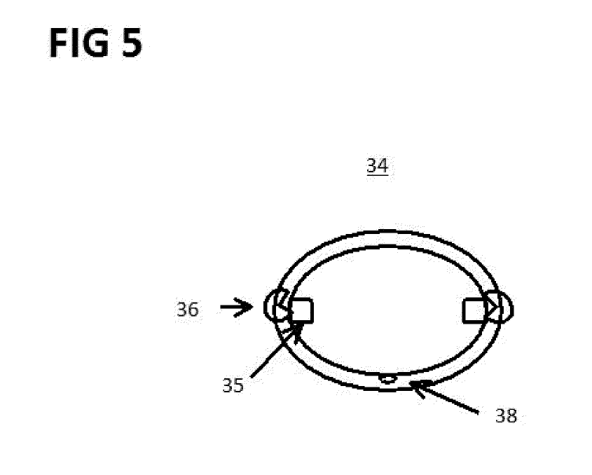

Turning to FIG. 5, shown therein is base 34 with a top button as in the embodiments of FIGS. 3-4 shown in a top view. In this view, lock actuator platform 35 can be seen as well as location 38 where the rod penetrates the base 34 to engage the actuating mechanism (not shown).

When the cylinder 33 is lowered onto the base 34, the spring tensioned platform(s) 35 are pushed down causing the locks 36 to rotate into the engaged position thereby locking the cylinder in place in recesses 37. Depressing the button or pedal, releases the locks 36 and also allows the platform(s) 35 to return to the upper position when the cylinder 33 is removed.

Alternatively, when the cylinder 33 is lowered onto the base 34, the button or pedal is depressed which actuates a rod 32 that moves the locks 36 into the engaged position locking the cylinder 33 into place. Depressing the button or pedal again, releases the locks so the cylinder 33 can be removed.

The trash container of the present invention may employ various actuating mechanisms (e.g., foot operated or hand operated) in many possible locations (e.g., top or bottom) without departing from the scope of the present invention.

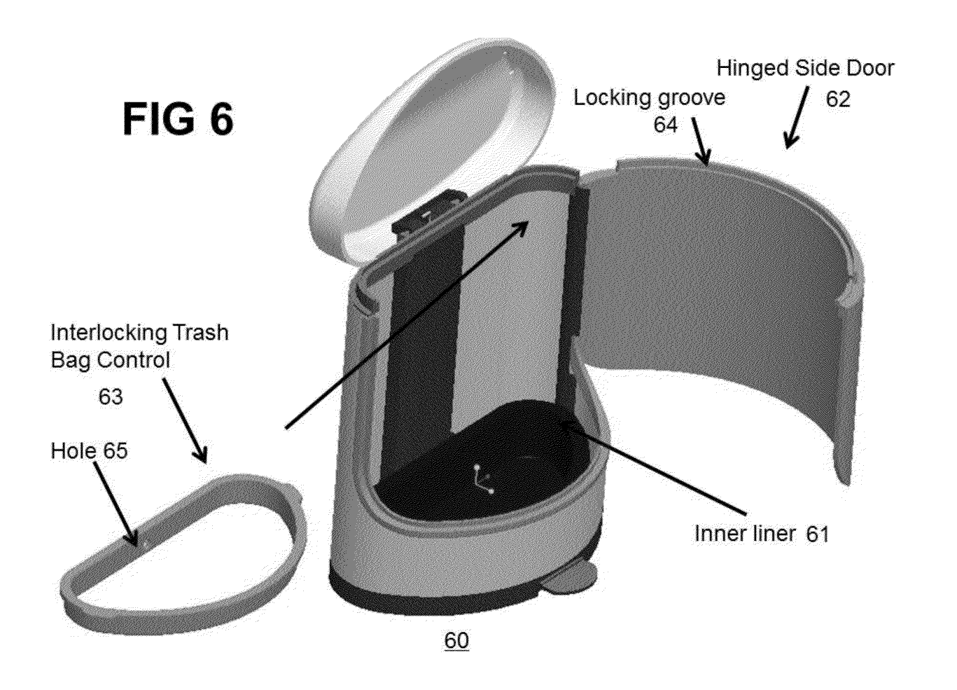

Turning to FIG. 6, shown therein is an exemplary embodiment of a trash can 60 according to one aspect of the present invention. The trash can 60 includes a liner 61 upon which a trash bag (not shown) rests. The trash can 60 employs a hinged door 62, which is hinged on the side. An interlocking trash bag control ring 63 is used to place on top of the hinged door 62 in interlocking groove 64 so that the door 62 cannot be opened while the ring 63 remains in place. The ring 63 has an upper lip around its circumference that interlocks with groove 64 on the can allowing the ring 63 to fit snugly around the top of the can. The interlocking feature serves the purpose of keeping the door from opening unintended as more and more trash is stuffed into the trash bag. The ring 63 is of varying heights depending on the size of the trash can. The ring 63 also holds the trash bag in an open and upright position so that trash can be easily put into the trash bag and so that the trash bag does not fall into the base of the can. Trash bag slack can also be taken up by inserting the excess bag into the back of the ring through a hole 65 in the ring wall.

A lid fits on the top of the interlocking ring and is designed to fit the shape of the outer container. A typical foot operated lid may be used along with the trash container of the present invention. Alternatively, a lid that is removed manually may be employed.

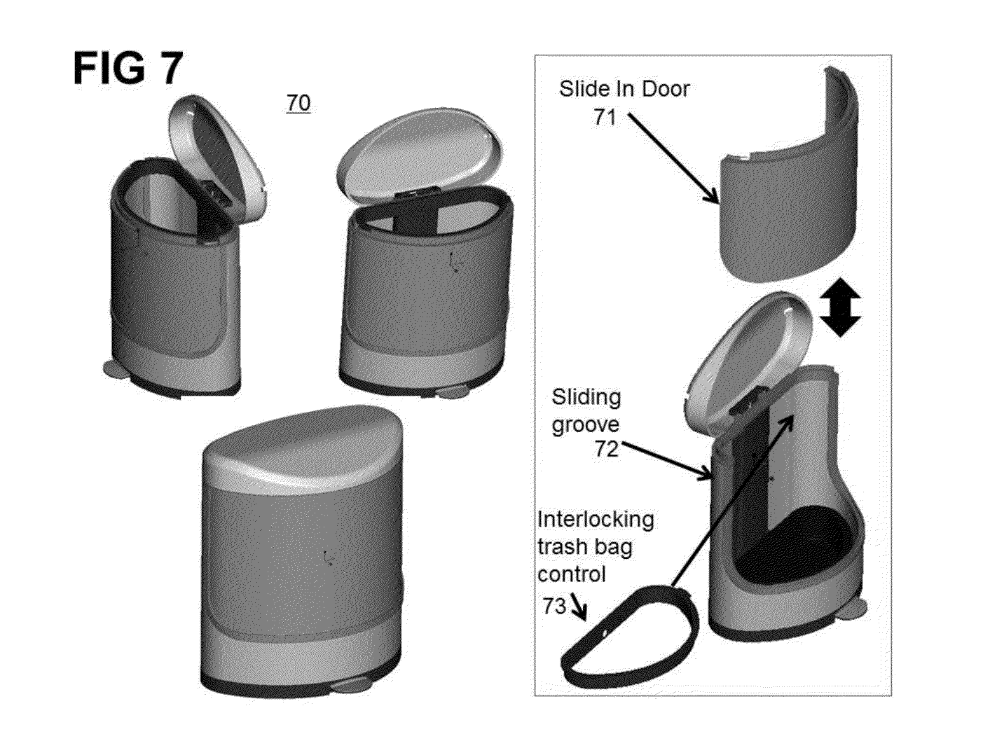

Turning to FIG. 7, shown therein is an exemplary embodiment of a trash can 70 according to one aspect of the present invention. This embodiment 70 employs a slide in door panel 71 that slides into place along sliding groove 72. The door panel 71 is locked in place via locking ring 73. FIG. 7 shows different views of the trash can 70 with the top open and closed with the sliding door locked in place.

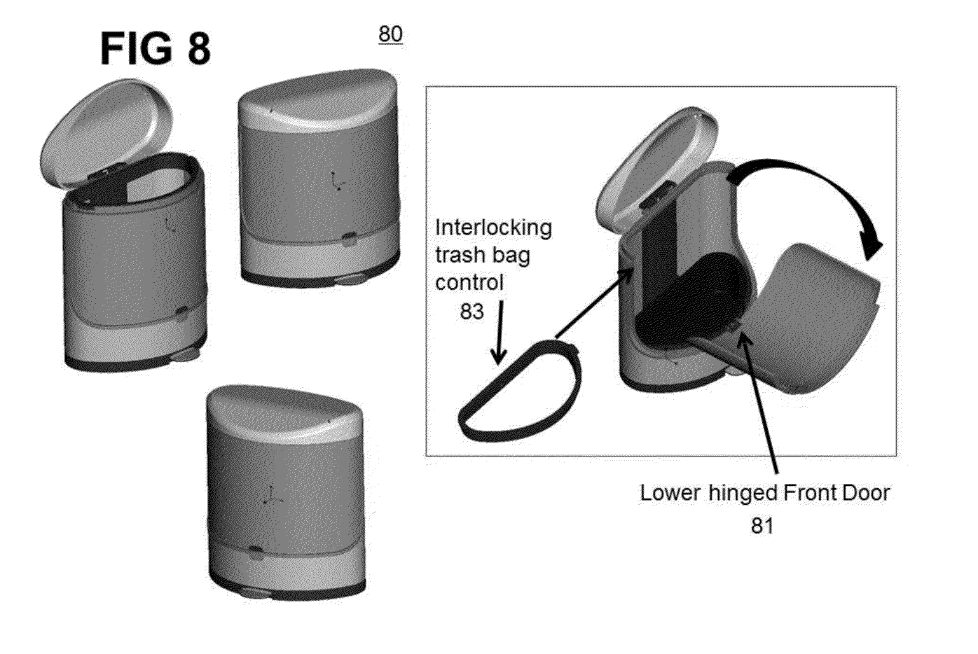

Turning to FIG. 8, shown therein is an exemplary embodiment of a trash can 80 according to yet another aspect of the present invention. This embodiment 80 employs a lower hinged front door 81. The door panel 81 is locked in place via locking ring 83. FIG. 8 shows different views of the trash can 80 with the top open and closed with the door locked in place.

The container used in the present invention may be cylindrical in shape or have a square cross-section, or any other shape without departing from the scope of the present invention.

What is claimed is:

1. An apparatus for containing trash comprising:
a liner including a closed bottom and a top having an opening;
a container having sides and a door panel, said container having a first end with an opening to accept a trash bag and a bottom end into which the liner fits, said container having a grooved top circumference; and
an interlocking ring fitting on the top of the grooved top circumference of the container and mating with the grooved top circumference, said ring locking the door in a closed position on the container.

2. The apparatus according to claim 1, wherein said door can only be opened when the ring is removed.

3. The apparatus according to claim 1, wherein the door is hinged on one side.

4. The apparatus according to claim 1, wherein the door is hinged on its bottom.

5. The apparatus according to claim 1, wherein the container further comprises a grooved surface into which the door panel slides into place along the grooves.

6. The apparatus according to claim 1, wherein the container has a circular cross section.

7. The apparatus according to claim 1, wherein the container has a rectangular cross section.

8. The apparatus according to claim 1, wherein the container has an elliptical cross section.

9. An apparatus for containing trash comprising:
a base unit including a closed bottom and a top having an opening;
a container with a first end having an opening to accept a trash bag and a second end having an opening, wherein the second end of the container fits into the base unit and a bottom of the trash bag is disposed at the bottom of the base unit; and
a user actuated locking mechanism releasably locking the container to the base unit, said user actuated locking mechanism to accept a force from a user foot to disengage the container from the base unit.

10. The apparatus according to claim 9, wherein the container may be lifted off the base unit without removing a filled trash bag from the base unit.

11. The apparatus according to claim 9, wherein the container has a circular cross section.

12. The apparatus according to claim 9, wherein the container has a rectangular cross section.

13. The apparatus according to claim 9, wherein the container has an elliptical cross section.

14. A method for enabling easy removal of a trash bag from a trash receptacle comprising:
locking a trash container holding the trash bag to base unit with a user actuated locking mechanism; and
releasing the user actuated locking mechanism upon application of a force from a user's foot to disengage the container from the base unit.

15. The method according to claim 14, wherein the container may be lifted off the base unit leaving a filled trash bag on the base unit when the user actuated locking mechanism is released.

16. A method for enabling easy removal of a trash bag from a trash receptacle comprising:
providing an access door on the trash container via which the trash bag can be removed; and
locking the access door with an interlocking ring that fits on a groove on top of the trash container when the access door is closed.

17. The method according to claim 16, wherein the trash bag may be lifted out of the trash container by removing the interlocking ring and then opening the access door.

18. The method according to claim 16, further comprising hinging the access door on one side.

19. The method according to claim 16, further comprising hinging the access door on its bottom.

20. The method according to claim 16, further comprising providing grooves into which the access door slides into place.
